(19) United States
(12) Patent Application Publication
(10) Pub. No.: US 2007/0071530 A1
(43) Pub. Date: Mar. 29, 2007

(54) APPARATUS, METHOD, AND COMPUTER PROGRAM PRODUCT FOR PAD IMAGE TRANSFER

(76) Inventor: Michael E. Woods, Tiburon, CA (US)

Correspondence Address: MICHAEL E. WOODS;PATENT LAW OFFICES OF MICHAEL E. WOODS, 112 BARN ROAD, TIBURON, CA, 94920-2602, US

(21) Appl. No.: 11/309,093

(22) Filed: Jun. 22, 2006

Related U.S. Application Data
(60) Provisional application No. 60/595,309, filed on Jun. 22, 2005.

(51) Int. Cl. B41J 2/315

(52) U.S. Cl. 400/120.01

(57) ABSTRACT

An apparatus and method for image sequence transfer onto one of a plurality of a pad medium pages while the pages are aggregated together. A preferred embodiment for a printer includes An image transfer apparatus, including a housing; an image transfer engine for transferring a series of images at a transfer position; and a transfer medium registration system for positioning a pad including a plurality of transfer media releasably secured to one another, wherein the transfer registration system locates a series of individual ones of the transfer media at the transfer position to receive different images of the series of images. The image sequence transferring method includes positioning a pad at a transfer position of a transfer engine, the pad including a plurality of transfer media releasably secured to one another; and transferring a series of images to successive ones of the transfer media serially positioned at the transfer position.

### CROSS REFERENCE TO RELATED APPLICATIONS

The present application is related to application Ser. No. 10/728,119 entitled APPARATUS, METHOD, AND COMPUTER PROGRAM PRODUCT FOR PAD TRANSFER filed 3 Dec. 2003 which is a CONTINUATION-IN-PART of application Ser. No. 10/628,749 entitled APPARATUS AND METHOD FOR PAD PRINTING filed 28 Jul. 2003, and is related to both application Ser. No. 10/628,820 entitled “APPARATUS AND METHOD FOR IMAGE CAPTURE AND PAD TRANSFER” and application Ser. No. 10/628,750 entitled “APPARATUS AND METHOD FOR ANIMATION PAD PRINTING” both filed on 28 Jul. 2003; and is related to Application Serial Number 10/618,107 entitled Image Transfer System and Method, filed 10 Jul. 2003 and application Ser. No. 10/728,118 entitled “APPARATUS, METHOD, AND COMPUTER PROGRAM PRODUCT FOR ANIMATION PAD TRANSFER” and filed on 3 Dec. 2003. These related applications are all hereby expressly incorporated by reference for all purposes.

### BACKGROUND OF THE INVENTION

The present invention relates generally to printing systems, and more particularly to printing systems for transferring a series of images to a pad of transfer medium.

There are many types of printing systems available today. These systems include dot-matrix, thermal printers, electrostatic image transfer, ink ejectment, and the like. These systems are adapted for printing successive images on individual sheets of separate pages drawn from a paper reserve stack. There are many different mechanisms for extracting individual sheets and directing them to the image application portion of the printer. What these printers have in common is that the printing systems are adapted for accessing, controlling, routing and printing a single sheet at time.

Pads of note paper, such as Post-It™ brand sticky note pads available from 3M Corporation of Minnesota, are well known. These pads include stacks of pages releasably secured to each other with a tacky adhesive that permits an individual page to be removed from the pad and re-adhered to another surface. This feature of releasable securement to successive surfaces is a desirable trait of these products.

Currently to produce an image on a sticky note, a user either writes or otherwise applies some text or graphic element on the topmost page of the pad of sticky note. Later, the user removes the note to reposition it to the desired location. It would be advantageous to use a printing system to apply the element to the sticky note page. However, the current printing systems are incapable of printing on such a pad. 3M offers a solution for printing on a preformed matrix of single layer note pages arranged in a standard 8″×11″ format for running through a conventional printer. 3M offers a solution for printing on a preformed matrix of single layer note pages arranged in a standard 8″×11″ format for running through a conventional printer called a PRINTSCAPE™ Personalized Note Kit product. This product features a matrix of Post-it® Notes included on a sheet of six notes arranged in three rows of two columns. A sheet of notes is compatible with existing printers for designing individual note content on a PC and printing them as desired, much like label design and printing software.

This solution has disadvantages in that it requires access to, and use of, a full-size printer and associated computer system to reproduce the element on the note. Also, the user has to obtain pages of the special format, as well as special software for use in cooperation with the computer system operating the printer.

Animation books are also known. An animation book includes a series of sheets of paper bound together. Each page has some image on it, with the collection of images related to each other to provide a sense of animation when the images are displayed successively. This effect is similar to motion picture technology in projecting many frames per second of one or more sets of related images.

Currently, quality animation books, or flip-books, are available commercially. It is known for an animator to hand apply sequenced images individually to sets of pages to produce a rudimentary animation book. However, such a solution does not produce animation books of sufficient quality, and the production is often limited to the animator's artistic skills. There are systems, including personal computers and software for generating animation sequences from images. But these sequences must be viewed on the computer system or converted into video/film presentations for later viewing. There are systems for viewing animation sequences (e.g., AVI viewers or Quicktime viewers) on a personal computers. Some formats provide for a series of individual images to be rendered in sequence to appear to produce an animation, while other formats provide for a series of base images (and encoded changes to the base images) to be rendered, again imparting a sense of animation.

It is also known to provide screen capture applications on a personal computer for a user to selectively capture all or a portion of a static display, window, control or other display element. The programs typically provide for some editing and permit a user to “paste” copies of the captured image into another application. It is also known to provide screen capture programs for creating an animation sequence of events portrayed on a display of a personal computer while the application is in a record mode.

However, these solutions do not permit a user to create a tangible output representation of the animation sequence. One does not typically speak of “printing a movie” though individual frames may be printed when the base format is suitable. A user may be able to copy the sequence onto various mediums (disk, CD, file or film) and “play them back” for display, though the user requires a personal computer or other suitable hardware to generate the intangible representations.

The related patent application include descriptions of apparatus, methods, and computer program products that have, describe, or make use of image transfer engines for effecting a pattern transfer relative to an object, often an element of a pad of laminar elements.

FIG. 1 is a functional schematic diagram of a prior-art impact printing system 100 including a “dot matrix” print head 105 that is laterally scanned across a page 110 and selectively transfers a preselected pin pattern by striking a ribbon 115 with one or more pins. A character is “built” or “stitched” during the scan by activating the correct pins (using a solenoid 120 attached to each pin) at each print head position during movement across the page. Early print heads included nine pins linearly aligned and later print heads included twenty-four pins in a single print head. The prior art moved to other technologies, including inkjet printers (and related ink ejectment technologies) and laser printers. In both systems, a scanning is performed across a print medium (inkjet) or across a print medium intermediate (laser drum) to build a desired final image. The prior art systems all include an electronic print transfer system in which the print head, the paper, or both, are moved to build the desired final image. In other words, the print head is designed to form successive image elements that are then “stitched” together in a precise and predetermined manner to produce the final image composite. To facilitate the “image assembly” the print heads of the prior art are one-dimensional structures in that they are either a point (the laser beam incident on the drum) or a line (the dot-matrix/inkjet) that successively builds a final image. These systems all provide flexibility in image generation but have a similar disadvantage in that a print time is limited by the scanning speed and resolution is defined by the element size and accuracy of the “stitching” of the image components.

It would be desirable to provide a simple and efficient apparatus, method, and computer program product for an image transfer engine, particularly for an engine that includes variability and flexibility in effecting rapid pattern transfer and/or image transfer onto soft/malleable surfaces, or for long/extended images.

### BRIEF SUMMARY OF THE INVENTION

The preferred embodiment of the present invention includes an image transfer engine having a two dimensional or three dimensional (hereafter, the discussion will use the term multi-dimensional to refer to two dimensional and/or three dimensional) print head for effecting an image transfer of a complete image with respect to a surface without scanning (e.g., lateral movement) or “stitching” of image elements. One preferred use of the present invention is in the electronic stamping/forming devices, methods, and computer program products of the related patent applications. In these devices, it is one feature to replicate some of the characteristics of the rubber stamp products in the versatility and speed of image application to a wide range of surfaces in many different orientations. The preferred embodiments offer the advantages of the rubber stamp products with the versatility of modifying the image associated with “operation” of the rubber stamp.

Implementations of the multidimensional print heads of the preferred embodiments may be used for embossers, Braille printers, formers (e.g., cutters for cookie/dough/playdough and similar malleable, deformable materials and foods), etchers for a wide range of materials. Two dimensional print heads will either image or cut/perforate depending upon a depth of the print head actuating mechanism relative to the material processed, while three dimensional print heads may simultaneously cut/perforate a material while image with shallower elements than those for the cutting/perforating.

An alternate preferred embodiment relates to an image transfer engine permitting a transfer of an image to a non-planar or soft, easily deformable surface, and for transfer of a continuous image having a potentially variable but virtually limitless length.

These and other novel aspects of the present invention will be apparent to those of ordinary skill in the art upon review of the drawings and the remaining portions of the specification.

### BRIEF DESCRIPTION OF THE DRAWINGS

FIG. 1 is a functional schematic diagram of a prior-art impact printing system including a “dot matrix” print head that is laterally scanned across a page and selectively transfers a preselected pin pattern by striking a ribbon with one or more pins;

FIG. 2 is an illustration of a representative multidimensional print head of a preferred embodiment;

FIG. 3 is an illustration of a representative multidimensional print head of a second preferred embodiment;

FIG. 4 is a schematic block diagram of an image transfer system using a plurality of multidimensional print head patterns to form a multidimensional print head;

FIG. 5 is a diagram illustrating a first preferred implementation for configurable image elements of the multidimensional print head shown in FIG. 3;

FIG. 6 is a diagram illustrating a second preferred implementation for configurable image elements of the multidimensional print head shown in FIG. 3;

FIG. 7 is a diagram illustrating a third preferred implementation for configurable image elements of the multidimensional print head shown in FIG. 3;

FIG. 8 is a diagram illustrating a representative multidimensional print head of third preferred embodiment;

FIG. 9 is a perspective schematic view of a preferred embodiment for a roller image transfer system;

FIG. 10 is a functional diagram (side view) of roller transfer system 900 of FIG. 9;

FIG. 11 is a perspective view of an alternate preferred embodiment of the roller transfer system shown in FIG. 9 and FIG. 10;

FIG. 12 is a functional diagram (side view) of roller transfer system 1100 of FIG. 11; and

FIG. 13 is a perspective view of a use of the roller transfer system of FIG. 11 and FIG. 12.

### DETAILED DESCRIPTION OF THE INVENTION

The present invention relates to a simple and efficient apparatus, method, and computer program product for an image transfer engine, particularly for an engine that includes variability and flexibility in effecting rapid pattern transfer. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

FIG. 2 is an illustration of a representative multidimensional print head 200 of a preferred embodiment. Print head 200 includes a plurality of image elements 205 (e.g., nineteen, though other implementations may use a different number that in some cases includes hundreds or thousands of image elements) that are each independently configurable. Each image element may be configured into a least one of two modes: an impression mode and an impression-less mode as determined whether the image element contributes to transfer of any particular image. The dotted line defines an image transfer region 210 for print head 200 that is often an aperture.

Image elements 205 are laterally fixed within region 210 and are implemented as uniformly sized pins that completely fill the expanse of the region. In other implementations, image elements 205 may not have (exclusively or non-exclusively) circular cross-sections, nor may all image elements 205 be the same size, the same cross-section, and/or the same composition as one or more of the other image elements 205. In some implementations, it may be desirable to dispose a conformable membrane, film, layer, sheet, or other surface over region 210. This surface could be used to achieve any of several purposes, including smoothing an image transferred from image elements 205 as an aid to blending the impression image element contributions in the final transferred image. The membrane would preferably be an elastomer membrane coupled to or otherwise responsive to the configuration of the individual image elements.

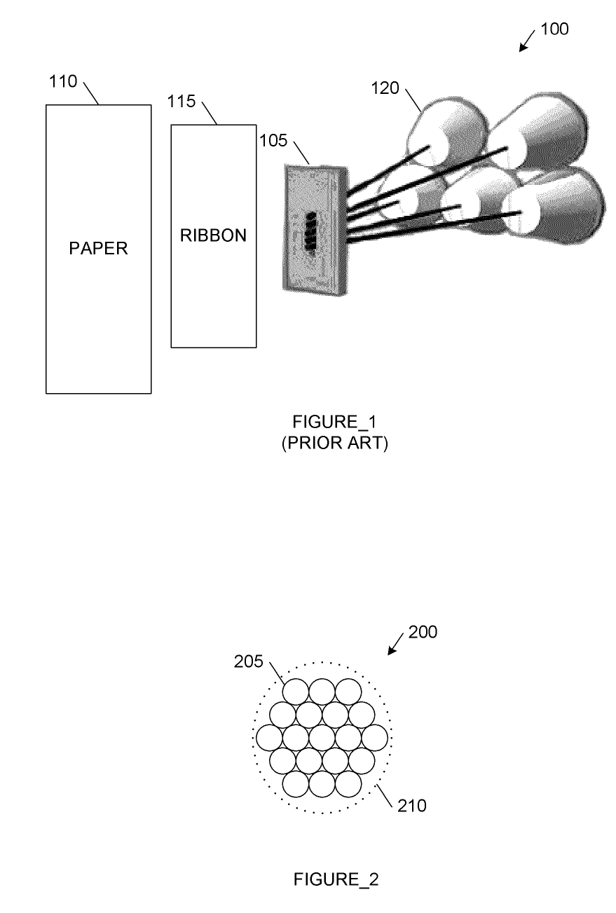

Configuration of the individual image elements 205 may be achieved using any one of numerous well-known structures and using some of the structures described later. One possible implementation is the use of a plurality of solenoids similar to those shown in FIG. 1. Each solenoid controls an image element, configuring it for the desired image and selecting from the available modes. The solenoids of FIG. 1 were designed for quickly (and as quietly as could be achieved accomplishing the other goals of the print head) reconfiguring the individual “dot” tungsten wires so the print speed could be as fast as the print head could accurately stitch the individual image components together. For solenoids used with print head 200, different design considerations could reduce the size/cost to achieve an even better result than may be the case using prior art solenoids. That is, in the preferred embodiments, the image formed from image elements need not change as quickly as is the case for printhead implementations, and the precision of image element is generally not as critical as successive images are not stitched. In the preferred embodiment, the collection of print elements 205 produce an aggregate image from relative position of impressioned/impression-less image elements.

For a two dimensional print head, image elements 205 will be controlled to be in one of the two modes: impression mode or impression-less mode. In the preferred embodiment for print head 200, extending any particular retracted image element 205 (relative to other image elements) configures it into the impression mode and retracting any particular extended image element 205 configures it into the impress-less mode. For a three dimensional print head, image elements may have positions intermediate fully extended and fully withdrawn to create a varying three dimension surface for the image to be transferred (e.g., into melted wax to produce a seal having varying depth features). In the preferred embodiment, print head 200 includes a structure, such as for example, an extended ring or lip, around region 210 (such as shown by the dotted line) protecting image elements 205. This ring, when longer than the extended length of image elements 205 in the impression mode) is constructed to withdraw to permit the impression mode image elements to transfer a collective image to a surface proximate region 210. The particular configuration of modes of the image elements (i.e., the image formed by the collective impression mode image elements) may be set as described in the related applications by, for example, coupling a control device to the image element mode controllers (e.g., the solenoids).

In operation, a set of image elements is configured into the impression mode to collectively define an image to be transferred. Region 210 is then juxtaposed a surface, with the impression-mode image elements effecting a pattern relative to the surface. The type of pattern is dependent upon the nature of the image transfer process used and the surface. For example, in one implementation, the image defined by the impression-mode image elements is “embossed” into the surface when print head 200 is stamped sufficiently hard given the relative strength and construction of the surface and the image elements. In other cases, such as stamping a softer material (e.g., dough) a shape may be cut out by having appropriate contiguous image elements in the impression mode. In still other cases, image elements 205 may have been coated with an ink or other material so that the ink or material is deposited/injected by the impression-mode image elements. Further, in some cases the image elements may be reactive to the surface, such as thermal elements when the surface is thermally responsive or radiation (e.g., light) when the surface is responsive to the particular radiation. Many other combinations and process types are possible for effecting image transfer using a suitably implemented print head 200. Image elements may include optical fibers or radiation waveguides disposed in bulk and provide a patterned optical image onto a surface—with any image transfer occurring such as by optical curing or reaction of a treated surface to wavelength/intensity or other attribute of radiation transmitted through the optical waveguide. In this case, the optical channels may not extend/retract; or the optical channels may be integrated into a moveable image element. In some cases, image elements may be hollow to transfer fluid/gas/liquid imaging components.

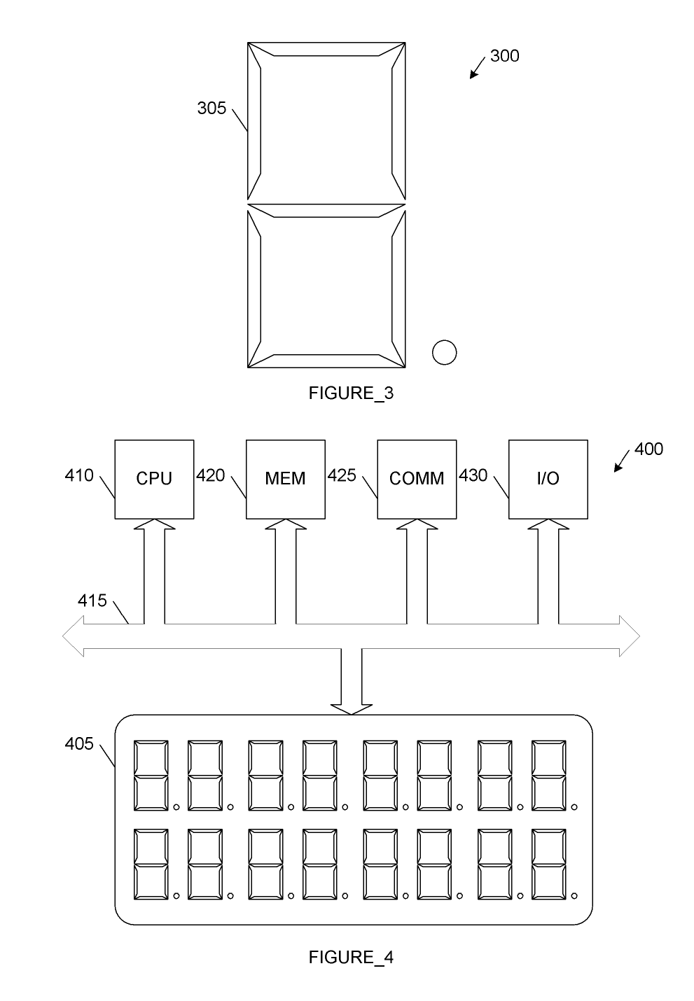

FIG. 3 is an illustration of a representative multidimensional print head 300 of a second preferred embodiment. Print head 300 appears similar to the segmented displays used in many conventional displays. Print head 300 differs from conventional alphanumeric segmented display elements in that the individual segments 305 are not display (optical) elements. Rather, each segment 305 is configurable into at least one of an impression-mode or an impression-less mode and used as described above in the discussion of the operation of print head 200. Print head 300 is a fairly simple embodiment, able to transfer a representation of any single numerical digit. It is well known to have display elements with differing segment patterns for more aesthetic, more accurate, and/or more complete representation of desired alphanumeric characters. As well known, some display patterns provide for fairly pleasing representation of many letters (upper and lower case), numbers and some punctuation symbols. Such display patterns may also be used for print head 300 rather than the illustrated pattern which is only shown in a simplified manner for ease in understanding.

FIG. 4 is a schematic block diagram of an image transfer system 400 using a plurality of multidimensional print head patterns 300 to produce a print head 405. System 400 also includes a central processing unit (CPU) 410 coupled to a bus 415 that is coupled in turn to print head 405, a memory 420, a communications unit 425, and an input/output (I/O) system 430. CPU 410 controls the configuration mode of the individual image elements 305 of print head 405 using program instructions and data stored in memory 420. Communications 425 provides for connectivity between system 400 and other devices/units, such as for example by any of the well-known wired/wireless communications protocols. System 400 may update program or data (e.g., stored image) information using communications unit 425, and the information transfer may be in either direction depending upon the particular implementation. I/O system 430 permits a user to select desired images, control the communications system, receive feedback of operation, and other interactions to and from system 400. In some cases, these interactions include the reading and storage of program and data information of system 400 relative to a removeable medium, such as a memory stick, memory card, or disk (magnetic or optical). Again, for ease of illustration, print head 405 is shown using the simplified display pattern of printhead 300 of FIG. 3, though other display patterns could be used, and spaces between patterns may also include additional image elements independently controlled by CPU 410.

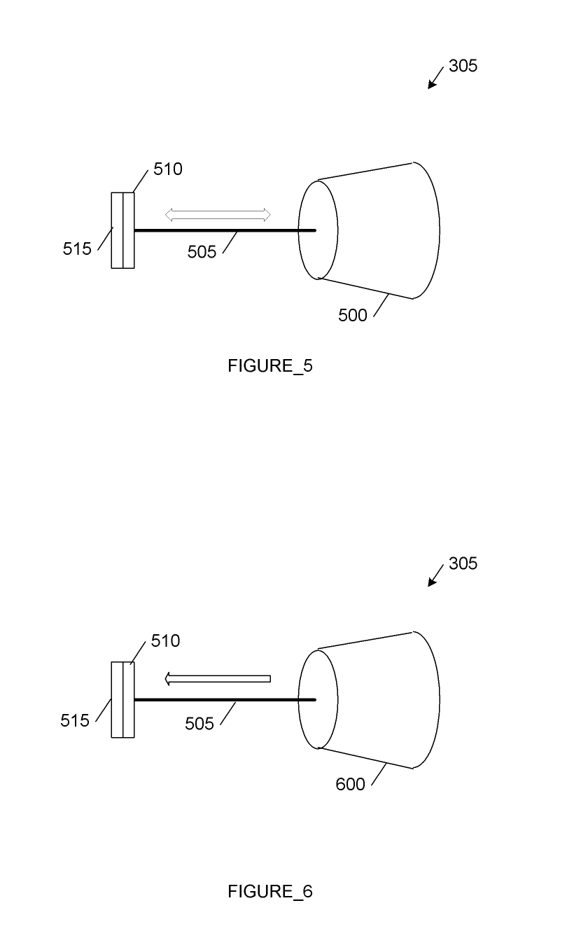

FIG. 5 is a diagram illustrating a first preferred implementation for configurable image elements 305 of multidimensional print head 300 shown in FIG. 3. Element 305 includes a configurator 500 (e.g., a solenoid) coupled (e.g., using a tungsten wire 505) to an image element base 510 having a transfer process-specific treatment 515 disposed on a surface of base 510. To simplify the present discussion, the structure will be described specific for an ink transfer process (e.g., print) so treatment 515 is an elastomer such as that used in conventional rubber stamp pads. In other processes, treatment 515 may be a resistive element that selectively heats for thermal transfer. CPU 410 may control configurator 500/treatment 515 when implemented as shown in FIG. 4.

FIG. 6 is a diagram illustrating a second preferred implementation for configurable image elements 305 of multidimensional print head 300 shown in FIG. 3. In this embodiment, element 305 includes a configurator 600 that is a latch and biasing system. Base 510 is biased to be in one mode (e.g., the impression mode) and configurator 600 selectively constrains its element 305 into the impression mode or permits transition to another mode during operation. Such a structure is suitable for “stamping” transfer processes as elements not in the impression mode are moved to the other mode during the operation. For two-dimensional print heads, elements 305 will either be restrained (e.g., latched) into the impression mode, or unlatched and permitted to be transitioned to the impression-less mode during operation. In three dimensional print heads, configurator 600 constrains movement intermediate the impression-less position and the impression position. CPU 410 may control configurator 600 when implemented as shown in FIG. 4.

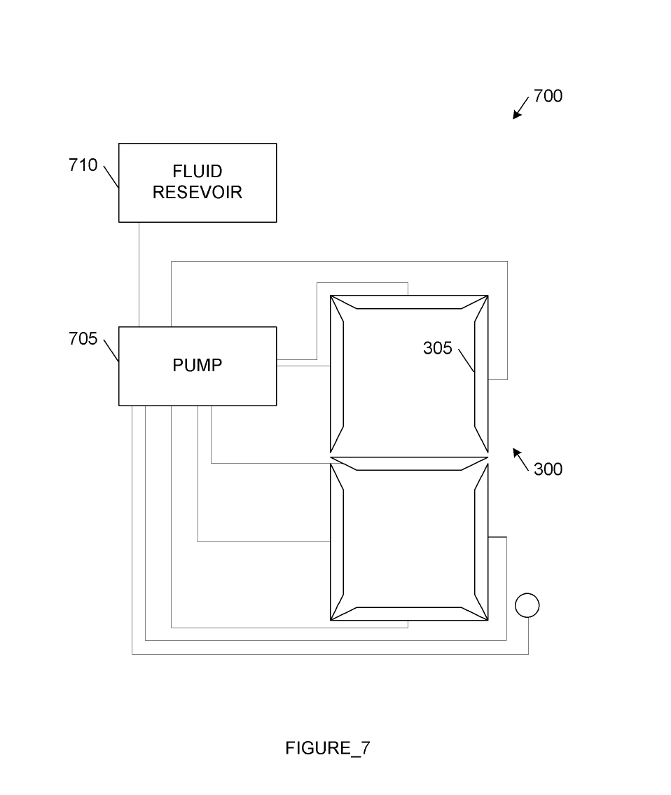

FIG. 7 is a diagram illustrating a third preferred implementation for a system 700 including configurable image elements 305 of multidimensional print head 300 shown in FIG. 3. In this embodiment, a configurator includes a pump 705 coupled between a reservoir 710 and each segment 305. Reservoir 710 may contain a fluid (e.g., an inert liquid) or gas (e.g., air, nitrogen, or carbon dioxide) that is moved independently into and out of each segment 305. Each segment 305 is configured as an expandable/constrictive chamber, bladder or vessel for example or other system responsive to fluid flow. The expansion/constriction of any particular element 305 controls whether it is in the impression mode or the impression-less mode. For example, an image element 305 is constructed to “balloon out” when expanded by fluid pumped into it which could be the impression mode. Each segment would selectively “balloon” out or shrink to the impress-less mode as controlled by pump 710. In some implementations, the fluid/gas may be configured for expulsion from each element 305 as controlled by a control system, such as shown in FIG. 4.

Such a structure may be formed in many different ways. For example, a substrate may have appropriately shaped cavities formed, the cavities individually communicated to pump 710 with an elastomer disposed over the cavities. The pumping of the fluid into the cavity expands the overlying the elastomer surface, creating a “bubble” that is appropriately shaped. CPU 410 may control pump 710. In an “air” operated system, the atmosphere may serve as reservoir 710 coupled through an inlet (screened to exclude particulates) to pump 705. Additionally, in such a system 700, it would be possible to have an electronically controlled configurator while the pump is actuated by the “stamping” action to drive fluid into the set of impression image elements at or near the instance of image transfer. Or image elements such as shown in FIG. 5 could be hydrostatically controlled by the liquid/fluid to move connecting elements.

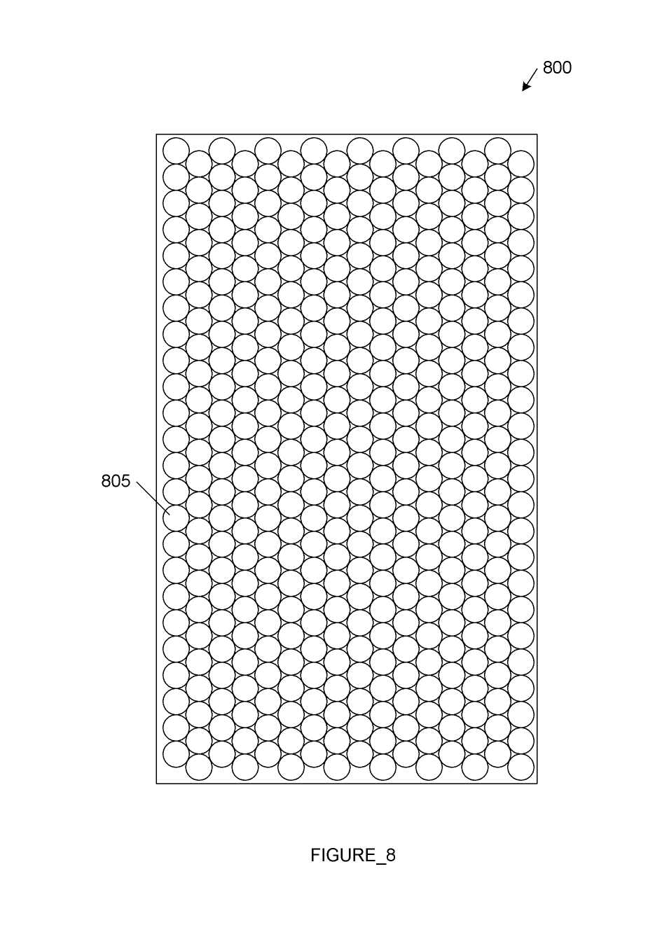

FIG. 8 is a diagram illustrating a representative multidimensional print head 800 of a third preferred embodiment. Print head 800 is a large-scale matrix of a plurality of ink ejectment (e.g., inkjet) nozzles 805, each nozzle independently actuable. The expanse of the matrix of nozzles 805 completely fills an image transfer region 810 so any desired image that is “imageable” by print head 800 is achieved without scanning of the print head or of the surface proximate region 810. In some implementations, due to the a number of nozzles, it may that there is some discernable or measurable delay between activation of a first one nozzle 805 and a last one nozzle 805 of the nozzles in an “impression” mode. In different implementations, the location of nozzles 805 within print head 800 may not match the specific pattern shown. Different implementations may require different layouts and different orientations among the individual nozzles. Print head 800 may be coupled into system 400 in lieu of print head 300 (likely with appropriate program and data modification) for operation. Not only orientation, but relative size and other configuration attributes of nozzles 805 may be varied from implementation to implementation or within a specific implementation. Similarly, each nozzle 805 may be an image element, such as element 205 shown in FIG. 2 for physical construction of an image for transfer.

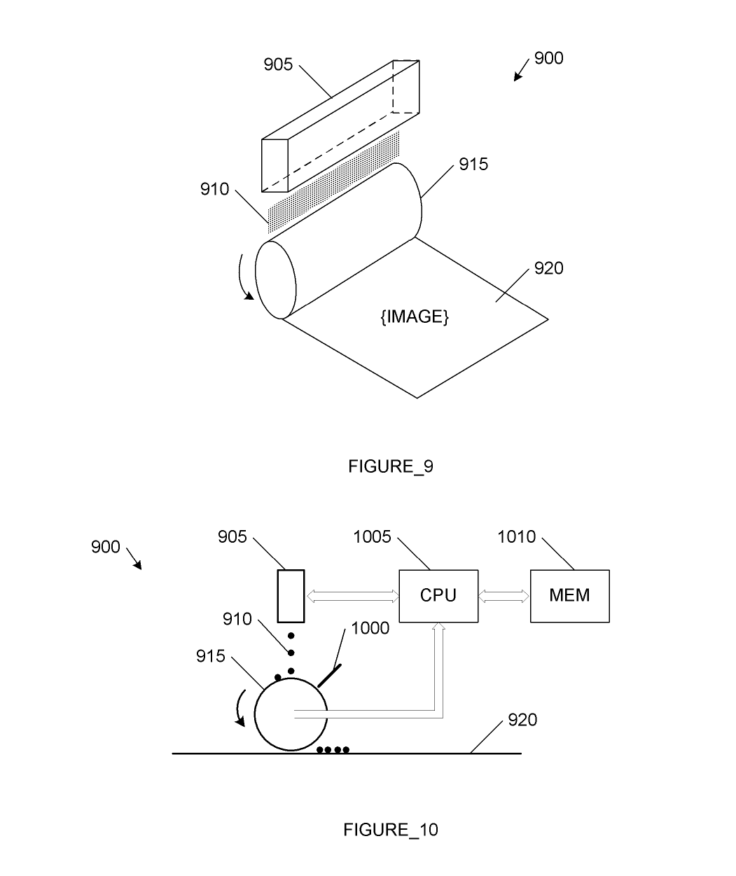

FIG. 9 is a perspective schematic view of a preferred embodiment for a roller image transfer system 900. System 900 includes an imaging engine 905 that deposits an image transfer medium 910 onto a roller 915 that in turn effectuates a pattern (e.g., an image) with respect to a surface of an image medium 920.

Advantages of system 900 include an ability to effectuate patterns to surfaces that are uneven, malleable, and/or deformable, as well as to effectuate virtually endless (as long as any replenishable supply used in the transfer process remains available) patterns with respect to appropriate surfaces.

In one preferred embodiment engine 905 includes an ink ejectment system (e.g., an inkjet print head disposed in line format to cover an entire width of roller 915) for forming a series of image element that are components of a final image that is transferred. Roller 915 is, in the preferred embodiment, a large diameter soft roller (somewhat “sponge-like) able to conform to various non-planar surfaces while able to receive transfer medium 910 and redeposit it on medium 920. The deposited image components are then transferred again from roller 915 onto medium 920 as roller 915 is rolled over the surface of medium 920.

FIG. 10 is a functional diagram (side view) of roller transfer system 900 of FIG. 9 illustrating additional details. Specifically, system 900 includes an excess transfer medium remover 1000, a processor 1005 coupled to a memory 1010 and roller 915 for controlling engine 905 in synchronism with the image transfer. That is, as roller 915 turns, a new appropriate image component is deposited on roller 915 by engine 905, and as roller 915 is moved faster or slower, system 900 maintains the appropriate image components on roller 915. System 900, in some implementations, includes additional functional features, some of which are shown in system 400.

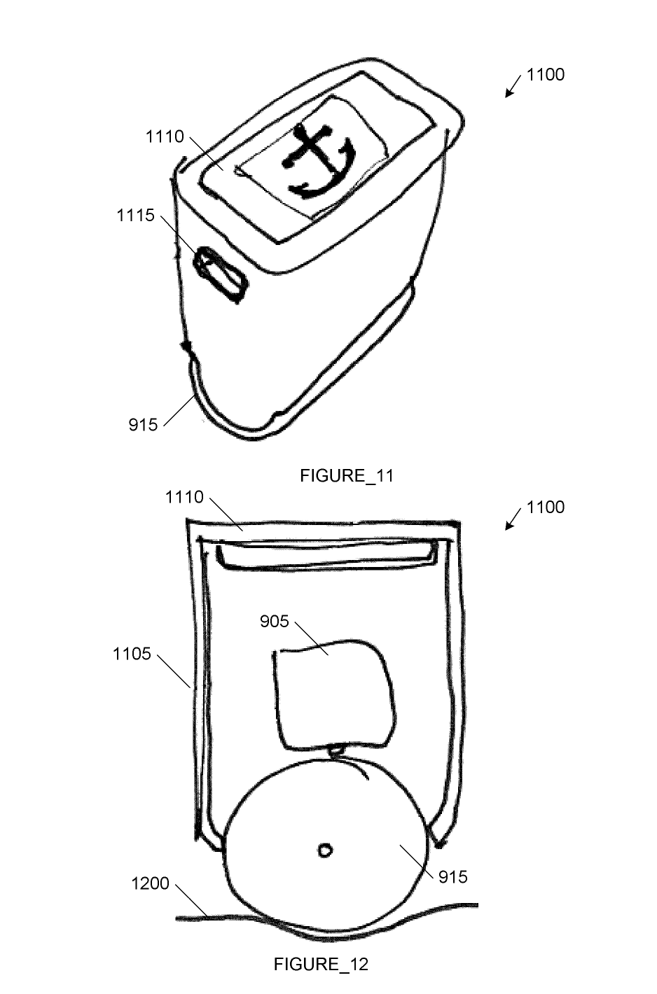

FIG. 11 is a perspective view of an alternate preferred embodiment of a roller transfer system 1100 from that shown in FIG. 9 and FIG. 10. System 1100 includes a hand held housing 1105 supporting a display 1110 and a data transfer port 1115 in addition to the system 900 components shown in FIG. 10. FIG. 12 is a functional diagram (side view) of roller transfer system 1100 of FIG. 11 illustrating display 1110, engine 905 and roller 920 operatively coupled to an image receiving surface 1200 (shown as soft/malleable surface having a shape that significantly changes in response to the image transfer process).

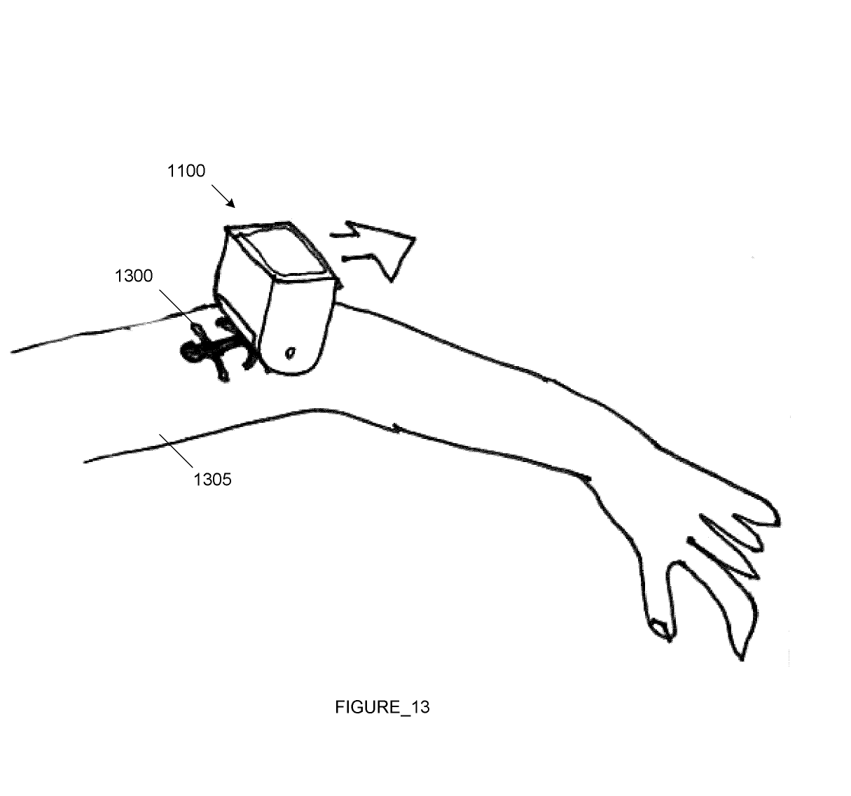

FIG. 13 is a perspective view of a use of roller transfer system 1100 of FIG. 11 and FIG. 12 to transfer an image 1300 (e.g., a tattoo) onto an arm 1305. A user operates system 1100 to select a desired image (verified by reference to the display) and then begins to roll system 1100 over arm 1305 to successively deposit image components onto roller 920 and then onto arm 1305.

One of the preferred implementations of the present invention is as a routine in an operating system made up of programming steps or instructions resident in a memory of a computing system shown in some of the figures, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

One of the preferred implementations of the present invention is as a routine in an operating system made up of programming steps or instructions resident in a memory of a computing system shown in FIG. 2, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

What is claimed as new and desired to be protected by Letters Patent of the United States is:

1. An image transfer engine, comprising:
a plurality of image elements with each element configurable in at least two modes including an impression mode and an impression-less mode, with an impression set of elements in said impression mode forming a complete pattern for transfer without scanning; and
a plurality of element controls, at least one coupled to each image element, for configuring said plurality of image elements into said modes.

2. The image transfer engine of claim 1 wherein said plurality image elements collectively define an entire image.

3. An image transfer engine, comprising:
a housing defining an aperture for an image transfer region;
a plurality of image elements, coupled to said housing, with each element configurable in at least two modes including an impression mode and an impression-less mode, with an impression set of elements in said impression mode forming a complete pattern in said region for transfer without scanning; and
a plurality of element controls, at least one coupled to each image element, for configuring said plurality of image elements into said modes.

4. A method for imaging, the method comprising:
selectively actuating each of first set of a plurality of image elements of an array of image elements to define an image for transfer; and
transferring said image to an object using said set of image elements.

5. A computer program product comprising a computer readable medium carrying program instructions for manufacturing a transport when executed using a computing system, the executed program instructions executing a method, the method comprising:
selectively actuating each of first set of a plurality of image elements of an array of image elements to define an image for transfer; and
transferring said image to an object using said set of image elements.

6. A propagated signal on which is carried computer-executable instructions which when executed by a computing system performs a method, the method comprising:
selectively actuating each of first set of a plurality of image elements of an array of image elements to define an image for transfer; and
transferring said image to an object using said set of image elements.
